(19) United States
(12) Patent Application Publication
(10) Pub. No.: US 2005/0172534 A1
(43) Pub. Date: Aug. 11, 2005

(54) Articulating trolling rod holder assembly

(76) Inventor: Anthony F. Arcabascio, Bayville, NJ (US)

Correspondence Address: CLIFFORD G. FRAYNE, 136 DRUM POINT RD, SUITE 7A, BRICK, NJ, 08723, US

(21) Appl. No.: 11/045,980

(22) Filed: Jan. 31, 2005

Related U.S. Application Data
(60) Provisional application No. 60/542,054, filed on Feb. 5, 2004.

(51) Int. Cl. A01K 97/10

(52) U.S. Cl. 43/21.2

(57) ABSTRACT

A rod holder for use when trolling from a fishing vessel, the rod holder having a tubular support member slidably receivable within the gunwale rod holder of the boat, the lower end of the support member being notched so as to engage in locking relationship with a cross bar at the lower end of the gunwale rod holder, the support member having articulating mounted thereon, a generally cylindrical rod holder rotatable from a generally horizontal, trolling orientation to a generally vertical orientation for ease of removal of the fishing rod from the generally cylindrical fishing rod holder when a strike has occurred. The generally cylindrical rod holder is limited in its articulation by means of a rocker arm which prevents the rod holder from rotating below the horizontal.

### BACKGROUND OF THE INVENTION

1. Field of the Invention

The present invention relates to fishing and in particular to a trolling rod holder in the gunwale rod holder of a fishing vessel trolling bait or lures from a fishing rod.

### RELATED APPLICATIONS

Applicant claims the benefit of provisional application Ser. No. 60/542,054, filed Feb. 5, 2004.

2. Description of the Prior Art

One method of fishing from a sport fishing boat is that of trolling. This consists of affixing bait or lures to the fishing line and releasing a desired length of line and then placing the butt end of the fishing rod into a rod holder, the rod holder being affixed in the gunwale rod holder at the rear or side of the boat. In this fashion, the fishing vessel moves through the water with the bait or lure being dragged behind the boat sometimes simulating a live fish. The fishing rod in the rod holder is oriented in a generally horizontal position. When a strike occurs, i.e. a fish has taken the bait or lure and has been hooked, the fisherman must remove the rod from the rod holder in order to operate the reel and to retrieve the fishing line and the hooked fish. Due to the horizontal orientation of the rod in the rod holder, the strength of the strike of the fish and the forward motion of the fishing vessel, it is not an easy task to engage the pole, and remove it from the rod holder in order to position it in a substantially vertical position to retrieve the line and the fish.

Fishing rod holders of the known type are currently formed by plates secured to the boats side or gunwale by screws and provided at the upper side with a fixed cylindrical sleeve which is the rod holder and supports the handle or butt end of the fishing rod keeping it in the desired orientation. Presently known fishing rod holders have several problems. Fishing rod holders of affixed type are secured to the boat by screws and therefore not easily removable. These present obstacles and hindrances when fishing is not occurring. Still further, these fished rod holders are subject to deterioration and corrosion since they are exposed to the sea water and salt air on a continuous basis.

Applicant's invention incorporates a generally cylindrical fishing rod holder engagable with the butt end of a fishing rod, with a tubular support member slidably receivable within the gunwale rod holder of the boat, the generally cylindrical fishing rod holder and cylindrical support member being mounted in articulating relationship so that when a strike on the bait or lure occurs, the fisherman can easily pivot the generally cylindrical fishing rod holder from a substantially horizontal position to a substantially vertical position for removal of the butt end of the fishing rod in order for the fisherman to retrieve line and the hooked fish.

### OBJECTS OF THE INVENTION

An object of the invention is to provide for a novel trolling fishing rod holder which allows the user to easily remove the rod from the holder when a strike on the bait occurs.

A still further object of the present invention is to provide for a novel trolling rod holder which is removably mounted to the gunwale of a fishing vessel.

A still further object of the present invention is to provide for a novel trolling rod holder wherein the rod holder and the support member are in articulating relationship allowing the user to rotate the rod holder from a substantially horizontal position to a substantially vertical position at the time of a strike to more facilely remove the rod from the rod holder.

A still further object of the present invention is to provide for a novel trolling rod holder which is impervious to salt air and sea water and which can be removed, cleaned and stored when not in use.

### SUMMARY OF THE INVENTION

A rod holder for use when trolling from a fishing vessel, the rod holder having a tubular support member slidably receivable within the gunwale rod holder of the boat, the lower end of the support member being notched so as to engage in locking relationship with a cross bar at the lower end of the gunwale rod holder, the support member having articulating mounted thereon, a generally cylindrical rod holder rotatable from a generally horizontal, trolling orientation to a generally vertical orientation for ease of removal of the fishing rod from the generally cylindrical fishing rod holder when a strike has occurred. The generally cylindrical rod holder is limited in its articulation by means of a stop member which prevents the rod holder from rotating below the horizontal.

### BRIEF DESCRIPTION OF THE DRAWINGS

These and other objects of the present invention will become apparent, particularly when taken in light of the following illustrations wherein:

FIG. 1 is an exploded side view of the trolling rod holder of the present invention;

FIG. 2 is an assembled side view of the trolling rod holder of the present invention in a trolling orientation;

FIG. 3 is a front view of an assembled trolling rod holder of the present invention;

FIG. 4 is an assembled side view of the trolling rod holder of the present invention in a fishing rod removal orientation;

FIG. 5 is a side view and partial cross section of the trolling rod holder of the present invention mounted to the gunwale of a fishing vessel in a trolling orientation; and

FIG. 6 is a side partial cross section view of the trolling rod holder of the present invention oriented such that the user can facilely remove the fishing rod from the rod holder in order to retrieve line and fish.

### DETAILED DESCRIPTION OF THE INVENTION

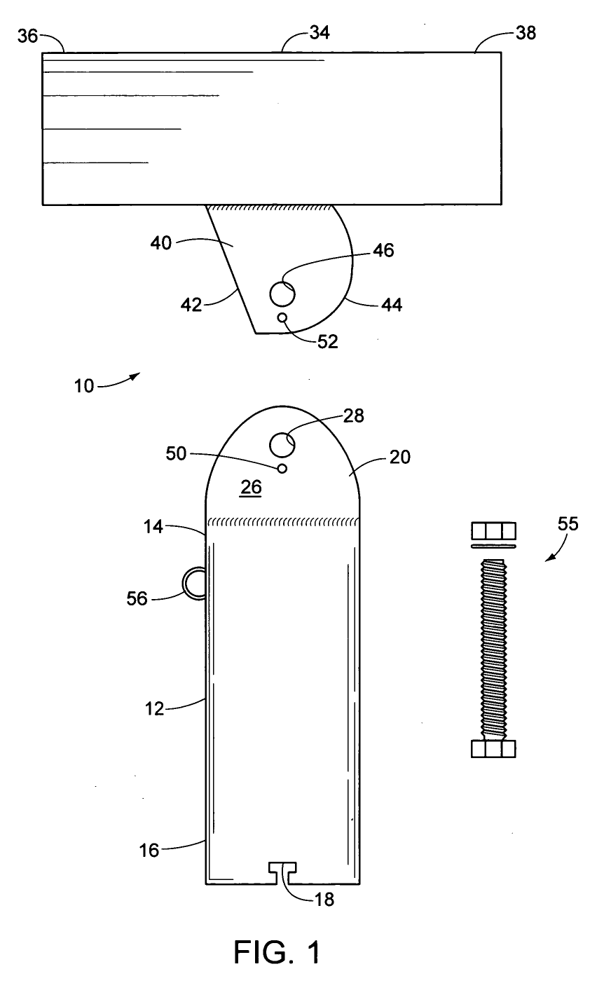

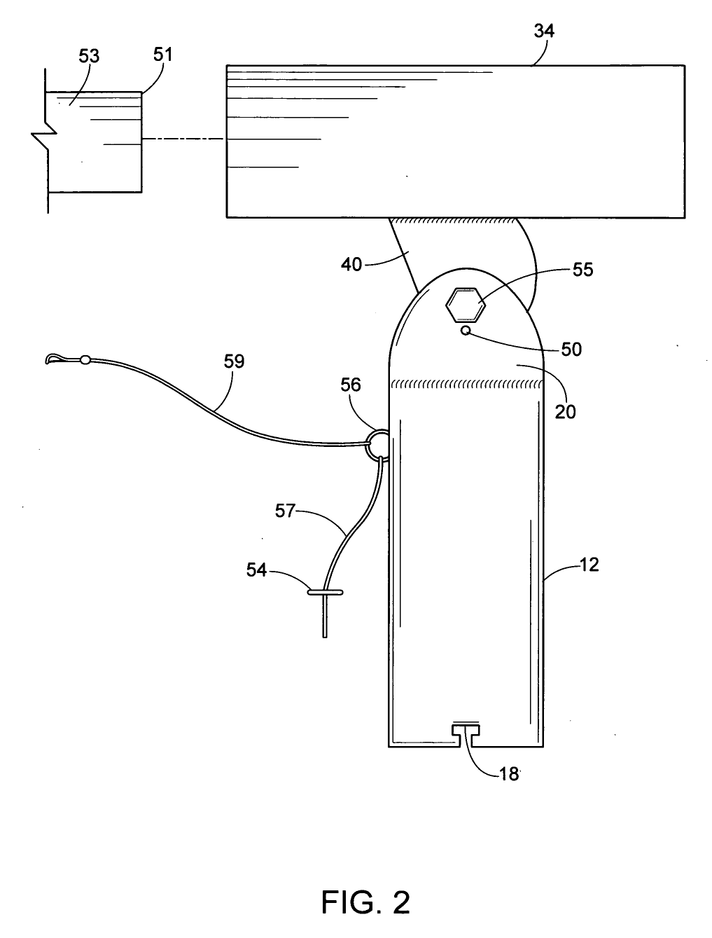

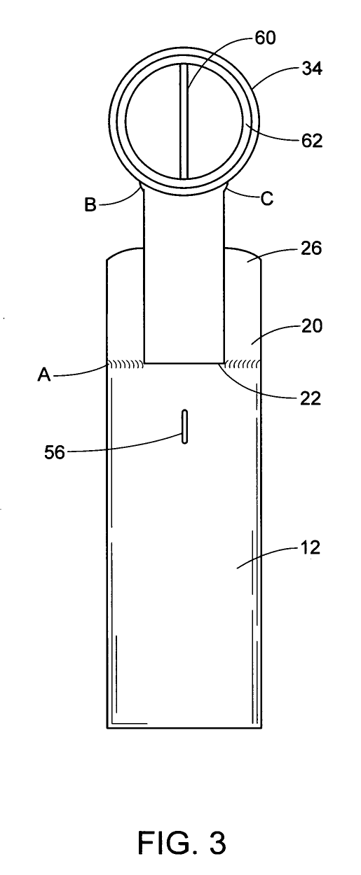

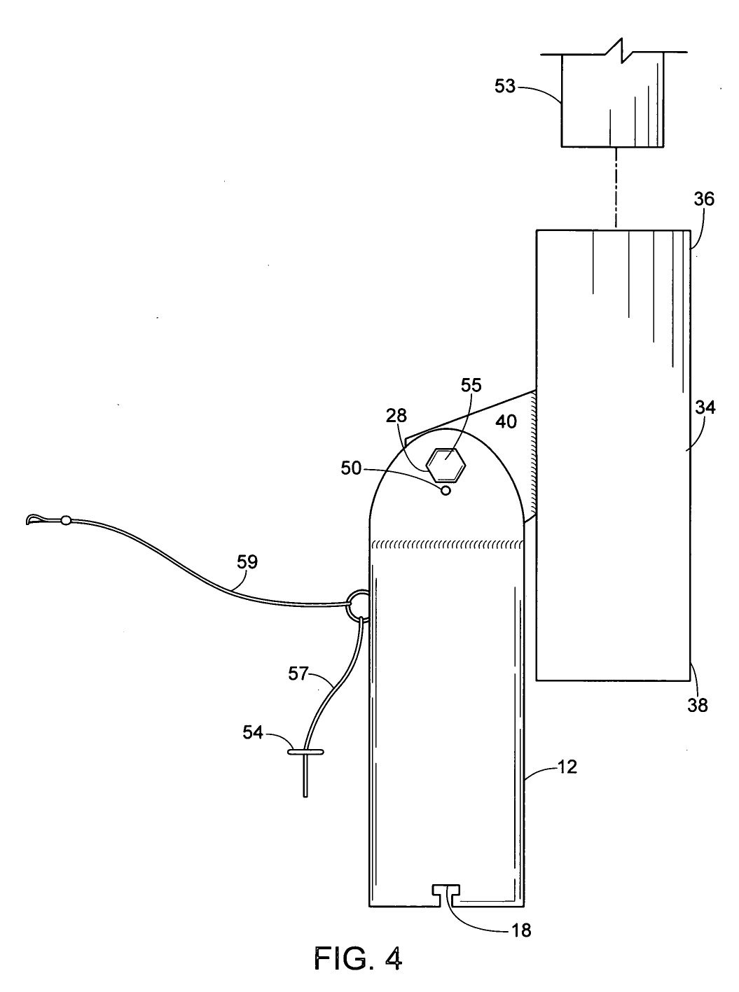

FIG. 1 is an exploded side view of the trolling rod holder assembly of the present invention, FIG. 2 is an assembled side view of the invention in a first orientation, and FIG. 3 is a front view of the assembled trolling rod holder assembly, and FIG. 4 is a side view in a second orientation.

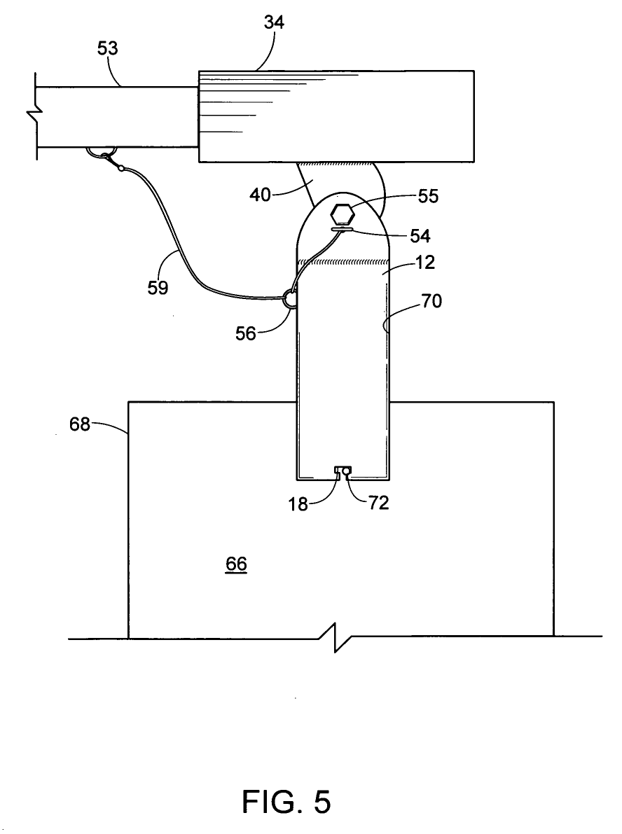

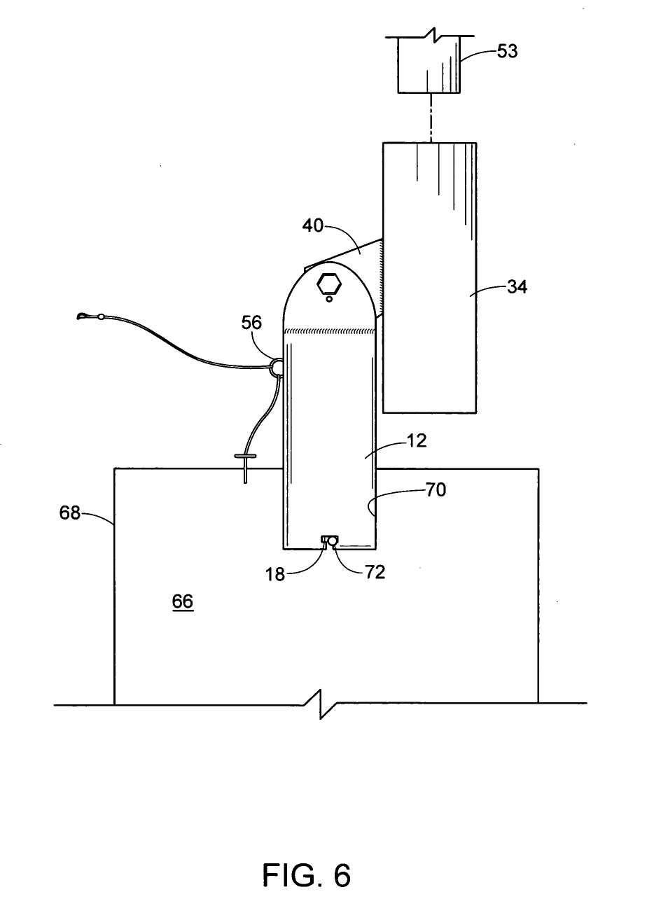

The assembly generally designated as 10 comprises a tubular rod holder support member 12 formed with a first end 14 and a second end 16. Second end 16, the lower end, is formed with opposing channel cutouts 18 which in this embodiment are T-shaped which allows holder support member 12 to be lockingly engaged with a cross pin (not shown) in the gunwale rod holder of the vessel as will be described in FIGS. 5 and 6. First end 14 has secured thereto, a cap member 20, cap member 20 having a solid base member 22 defining a contact surface and two spaced apart upstanding arms 24 and 26. Upstanding spaced apart arms 24 and 26 have at least one aligned throughbore 28 passing there through.

Secured in articulating relationship with tubular rod holder support member 12 is a generally cylindrical tubular rod holder member 34 having a first end 36 and a second end 38. Tubular rod holder member 34 has a depending rocker arm 40 secured thereto. Depending rocker arm 40 is of a thickness equal to the distance between spaced apart upstanding arms 24 and 26 on cap member 24 of tubular rod holder support member 12. Depending rocker arm 40 has a generally planar front face 42 and an arcuate rear face 44. Front face 42 cooperates with the contact surface defined by base member 22 to serve as a stop thereby limiting the downward rotational arc of first end 36 of rod holder member 34. Depending rocker arm 40 has at least one aperture 46 passing there through, aperture 46 being alignable with apertures 28 in spaced apart upstanding arms 24 and 26 when depending rocker arm 40 is slidably positioned there between. A securing means 55 is then secured through apertures 28 and 46 to secure rocker arm 46 and cylindrical tubular rod holder member 34 to rod holder support member 12. In the illustration, the securing means is a hex bolt, washer and hex nut. In the configuration illustrated, the rocker arm 44 and tubular rod holder member 34 can be rotated from a substantially horizontal position as illustrated in FIG. 2 to a substantially vertical position as illustrated in FIG. 4.

The orientation as illustrated in FIG. 2 would be set when the user desired to troll for fish. The butt end 51 of a fishing rod 53 would be slidably inserted into cylindrical tubular rod holder member 34 after line and bait had been released from the reel. When a strike on the bait occurs, the user would pivot or rotate (See FIG. 4) cylindrical tubular rod holder member 34 and rocker arm 40 such that second end 38 of cylindrical tubular rod holder member 34 moved in a downward arc and the set first end 36 of rod holder member 34 would move in an upward arc until the rod holder member 34 was in the substantially vertical position. The user then could facilely remove the pole from the rod holder member 34 in order to begin to reel in the fish.

Several additional features may be incorporated in the rod holder assembly 10 of the present invention. A second aperture 50 can be alignably formed through upstanding arms 24 and 26, and a similar alignable aperture 52 could be formed through rocker arm 40, apertures 50 and 52 being alignable when the tubular rod holder member 34 is in a substantially horizontal position. These aligned apertures 50 and 52 would be for receipt of a locking pin 54 which would be insertable there through in order to maintain the cylindrical tubular rod holder member 34 in the desired orientation, i.e. substantially horizontal. Pin 54 could be affixed by suitable means such as wire 57 into a ring member 56 secured to the outer circumferential surface of tubular rod holder support member 12. Ring member 56 may also serve an additional purpose as being an attachment point for a rod securing strap 59 which would be attached to ring 56 and be secured to a connector on the fishing rod 53, so as to prevent its being pulled from the rod holder member 34.

Additionally, rod holder member 34 may be formed with a cross pin 60 proximate the second end 38, cross pin 60 designed to engage the butt end 51 of the fishing rod 53 when inserted into tubular rod holder member 34. Additionally, tubular rod holder member 34 may also have a polymeric or plastic sleeve insert 62 in order to protect the butt end 51 of the fishing rod 53 from undue wear.

FIGS. 5 and 6 are side views of the trolling rod holder assembly 10 of the present invention illustrating the manner which they are secured to the fishing vessel. The portion of the fishing vessel shown is illustrated in cross section in order to illustrate the manner in which the rod holder support member 12 is secured.

The gunwale 66 of the fishing vessel 68 is formed with a plurality of bores or gunwale rod holders 70 for the receipt or temporary storage of fishing rods. The rod holder assembly 10 of the present invention would be mounted in these bores or gunwale rod holders. The rod holder support member 12 would be slidably received into a selective bore 70 such that the T-shaped channel cutouts 18 would engage a cross pin 72 at the lower portion of the bore 70. Rod holder support member 12 would engage the cross pin 72 with the vertical portion of the channel cutout 18 and then be twisted so as to position the cross pin 72 in the horizontal portion of the channel cutouts 18. This releasably secures the rod holder support member 12 in the bore. The user could then insert a fishing rod into the tubular rod holder member 34, secure the pole with the securing strap 59 and commence trolling for fish. When a strike is detected, the user would rotate tubular rod holder member 34 to a vertical orientation as illustrated in FIG. 6 and remove the rod from the rod holder member 34 in order to engage in landing the fish. In removing the fishing rod from tubular rod holder member 34, the user would first remove pin 54 if it was engaged through apertures 50 and 52. The user would also disengage the securing strap 59 from the fishing pole so as to allow the user to remove the fishing pole and move freely about the deck.

Rod support member 12 is tubular. Cap member 20, upstanding arms 24 and 26 and contact surface 22 are solid. Therefore the cap 20 would be welded to the rod holder support member 12 about the circumference designated as “A” in FIG. 3. Similarly, the tubular rod holder member 34 is tubular, but rocker arm 40 is of solid construction. These two elements would be joined by a weld at the locations identified as “B” and “C” in FIG. 3. There may be other simple means of attachment, but Applicant has found this method of fabrication to be viable.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

1. An articulating trolling rod holder assembly for trolling for fish from a vessel, the articulating trolling rod holder assembly comprising:
a tubular support member having a first upper end and a second lower end;
a cap member secured to said first upper end of said tubular support member, said cap member having opposing upstanding support arms defining a contact surface there between, said opposing upstanding support arms having aligned apertures there through;
a tubular rod holder defined by a first end and a second end, said tubular rod holder having a rocker arm depending there from, said rocker arm having an aperture there through, said aperture alignable with said aligned apertures in said upstanding support arms; and
a securing means secured through said apertures in said upstanding support arms and said aperture in said rocker arm so as to position said tubular rod holder in articulating relationship with said tubular support member for a pivot or rotation from a horizontal orientation to a vertical orientation for facilely removing a fishing rod from said tubular rod holder.

2. The articulating trolling rod holder assembly in accordance with claim 1 wherein said rocker arm on said tubular rod holder is formed with a planar front face and an arcuate rear face permitting pivot or rotation of said tubular rod holder from a horizontal orientation to a vertical orientation, said planar front face engageable with said contact surface of said cap member so as to limit said rotation of said tubular rod holder to a horizontal orientation.

3. The articulating trolling rod holder assembly in accordance with claim 1 wherein said second lower end of said tubular support member is formed with opposing channel cutouts lockingly engageable in a bore formed on a gunwale of said fishing vessel.

4. The articulating trolling and rod holder assembly in accordance with claim 1 wherein said tubular support member has formed on the outer circumference thereof, a connecting ring.

5. The articulating trolling rod holder assembly in accordance with claim 4 wherein said opposing upstanding arms of said cap member and said rocker arm of said tubular rod holder have formed there through an alignable second aperture for receipt of a securing pin, said securing pin flexibly attached to said ring member.

6. The articulating trolling rod holder assembly in accordance with claim 4 wherein said ring member has secured thereto a securing strap in communication with and attached to said fishing rod when said fishing rod is positioned in said articulating trolling rod holder assembly.

7. The articulating trolling rod holder assembly in accordance with claim 1 wherein said tubular rod holder has a polymeric sleeve inserted therein for engagement with a butt end of said fishing rod.

8. The articulating trolling rod holder assembly in accordance with claim 1 wherein said articulating trolling rod holder assembly is removable from said gunwale of said fishing vessel for cleaning and storage.

9. The articulating trolling rod holder assembly in accordance with claim 1 wherein said articulating trolling rod holder assembly is fabricated from a material impervious to salt water and salt air.
